(19) United States
(12) Patent Application Publication
(10) Pub. No.: US 2008/0183803 A1
(43) Pub. Date: Jul. 31, 2008

(54) Methods and apparatus for providing access to a digital media asset

(75) Inventors: Christopher Hassett, Falmouth, MA (US); Gregory Hassett, Cambridge, MA (US)

Correspondence Address: WOLF GREENFIELD & SACKS, P.C., 600 ATLANTIC AVENUE, BOSTON, MA, 02210-2206, US

(73) Assignee: Adela Group, LLC, Falmouth, MA (US)

(21) Appl. No.: 11/715,029

(22) Filed: Mar. 7, 2007

Related U.S. Application Data
(60) Provisional application No. 60/898,609, filed on Jan. 31, 2007.

(51) Int. Cl. G06F 15/16; G06Q 30/00

(52) U.S. Cl. 709/203; 705/14

(57) ABSTRACT

Embodiments of the invention relate to hosting digital media assets on a hosting server that were uploaded to the hosting server by a user. When a viewer accesses a digital media asset, the viewer may be directed to a promotional opportunity, such as, for example, an entry into a sweepstakes. In addition, when the viewer takes an action resulting from accessing the digital media asset, the user who uploaded the digital media asset to the hosting server may be provided with a reward.

### RELATED APPLICATIONS

This application claims the benefit under 35 U.S.C. §119(e) of U.S. provisional patent application Ser. No. 60/898,609, entitled REWARDING SHARING OF DIGITAL MEDIA CONTENT, filed on Jan. 31, 2007, under attorney docket no. A0888.70000US00, which is hereby incorporated by reference herein in its entirety.

### FIELD OF THE INVENTION

Embodiments of the present invention relate to hosting digital content.

### DESCRIPTION OF THE RELATED ART

Use of the Internet has become a convenient and common way to share user-generated content. As used herein, user-generated content is defined as any digital media asset created or captured by a member of the Internet community, including still images, video, audio, and/or any combination thereof.

Users of the Internet frequently share user-generated content via e-mail or by uploading the content to publicly accessible World Wide Web (WWW) hosting services, which permit users to create accounts, upload content, and make the content available for other users to access.

### SUMMARY

One embodiment is directed to a method of publishing a digital media asset comprising acts of: receiving, at at least one server that provides a publicly accessible interface that permits digital media assets to be provided to the at least one server, a first digital media asset provided by a user via the publicly accessible interface; and publishing the first digital media asset and at least one activatable item associated with the first digital media asset that, when activated by a viewer of the first digital media asset, causes information identifying the user to be transmitted to a target server and directs the viewer to a promotional opportunity.

Another embodiment is directed to a method comprising acts of: viewing a first digital media asset stored on at least one server that provides a publicly accessible interface that permits digital media assets to be provided to the at least one server, the first digital media asset having been provided to the at least one server by a user via the publicly accessible interface; activating at least one activatable item associated with the first digital media asset; and in response to activating the at least one activatable item, causing information identifying the user to be transmitted to a target server and receiving a promotional opportunity.

A further embodiment is directed to a method of hosting a first digital media asset stored on at least one server that provides a publicly accessible interface that permits digital media assets to be provided to the at least one server, the first digital media asset being provided to the at least one server by a user via the publicly accessible interface and being associated with at least one activatable item that, when activated, causes information identifying the user to be transmitted to the at least one server. The method comprises acts of: in response to a viewer of the first digital media asset activating the at least one activatable item, receiving, at the at least one server, the information identifying the user; and providing to the viewer content that directs the viewer to a promotional opportunity.

Another embodiment is directed to a method of accessing a first digital media asset stored on at least one server that provides a publicly accessible interface that permits digital media assets to be provided to the at least one hosting server, the first digital media asset having been provided to the at least one server by a user via the publicly accessible interface and being associated with at least one activatable item that, when activated, causes information identifying the user to be transmitted to the at least one server. The method comprises acts of: activating the at least one activatable item, thereby causing the information identifying the user to be transmitted to the at least one server; and in response to activating the at least one activatable item, receiving a promotional opportunity.

A further embodiment is directed to a method of hosting a first digital media asset stored on at least one server that provides a publicly accessible interface that permits digital media assets to be provided to the at least one server, the first digital media asset being provided to the at least one server by a user via the publicly accessible interface, the method comprising acts of: determining that a viewer has accessed the first digital media asset; and in response to determining that the viewer has taken an action resulting from accessing the first digital media asset, providing the user with a promotional opportunity.

Another embodiment is directed to a method of hosting a first digital media asset stored on at least one server that provides a publicly accessible interface that permits digital media assets to be provided to the at least one server, the first digital media asset being provided to the at least one server by a user via the publicly accessible interface. The method comprises acts of: determining that a viewer has accessed the first digital media asset; in response to determining that the viewer has accessed the first digital media asset, directing the viewer to a promotional opportunity; and in response to determining that the viewer has taken an action in connection with accessing the first digital media asset, providing the user with a reward.

A further embodiment is directed to a method of publishing a digital media asset comprising acts of: receiving, at at least one server that provides a publicly accessible interface that permits a member of the general public that meets specified eligibility standards to create a user account and to upload digital media assets to the at least one server via the account, wherein at least two million members of the general public meet the specified eligibility standards, and wherein a first digital media asset is provided to the at least one server by a user via a first user account created by the user; and publishing the first digital media asset and at least one activatable item associated with the first digital media asset, wherein the at least one activatable item, when activated by a viewer of the first digital media asset, directs the viewer to a promotional opportunity.

Another embodiment is directed to a method of publishing a digital media asset comprising acts of: receiving, at at least one server that provides a publicly accessible interface that permits digital media assets to be provided to the at least one server, a first digital media asset provided by a user via the publicly accessible interface; publishing the first digital media asset and the at least one activatable item associated with the first digital media asset that, when activated by a viewer of the first digital media asset, causes information identifying the user to be transmitted to a target server and directs the viewer to a first promotional opportunity; in response to a first viewer activating the at least on activatable item, receiving at the at least one server the information usable to identify the user; identifying the user using the information identifying the user; and in response to determining that the viewer has taken an action in connection with accessing the first digital media asset, providing the user with a second promotional opportunity.

### BRIEF DESCRIPTION OF DRAWINGS

FIG. 1A is a block diagram of a system in which a digital media asset hosted on a hosting server is published via e-mail, in accordance with one embodiment of the invention;

FIG. 1B is a block diagram of a system in which a digital media asset hosted on a hosting server is published via a separate server, in accordance with one embodiment;

FIG. 1C is a block diagram of a system in which a digital media asset hosted on a hosting server is published via the hosting server, in accordance with one embodiment;

FIG. 2 is a diagram of digital media asset published with an activatable item, in accordance with one embodiment;

FIG. 3A is a block diagram of a system in which a viewer of a digital media asset is directed to a promotional opportunity, in accordance with one embodiment;

FIG. 3B is a diagram of web page that presents a promotional opportunity, in accordance with one embodiment;

FIG. 4A is a block diagram of a system in which a hosting server that hosts a digital media asset serves a target server to receive information identifying a user who uploaded the digital media asset to the hosting server, in accordance with one embodiment; and

FIG. 4B is a block diagram of a system in which a target server separate from a hosting server that hosts a digital media asset receives information identifying a user who uploaded the digital media asset to the hosting server, in accordance with one embodiment.

### DETAILED DESCRIPTION

As web-based hosting and content sharing services have increased in popularity, the competition among these services to attract subscribers has increased. To make use of their service more attractive to potential subscribers, some services monetarily compensate subscribers whose uploaded assets have been viewed a large number of times. For example, MetaCafe (www.metacafe.com) currently pays a user five dollars for every thousand views of an asset uploaded by the subscriber. However, the subscriber does not receive any payment until after his or her asset has been viewed at least 20,000 times.

Applicants have appreciated that such systems of compensation are attractive only to those who upload assets having mass appeal, and they do not provide incentive for those who upload content intended for only a small number of people or is otherwise not expected to be viewed a large number of times. For example, someone who uploads family vacation photos to a service to share amongst his family and close friends would likely not receive any benefit from a system that only compensates those whose assets have been viewed a large number of times, and therefore would not be incentivized by such a reward system to host his or her content via a service that offers such a reward system.

Compensation systems of the type described above rely upon monetizing viewer traffic. There are many ways to monetize the viewer traffic, but virtually all the value of the viewer traffic is directly proportional to its volume. Thus, Applicants have appreciated that it may be impractical to directly compensate a user of a hosting service for small volumes (e.g., each time an asset uploaded by the user is viewed). As used herein, the term “user” refers to a member of the Internet community who uploads one or more digital media assets to a hosting service. Further, as used herein, the term “viewer” refers to a member of the Internet community who views one or more digital media assets hosted via a hosting service.

As discussed above, it may be impractical to directly compensate a user whose asset is viewed a small number of times. That is, such users may be entitled to very small quantities of money (perhaps even fractions of a penny). Distributing these very small quantities of money, particularly to a large number of users, may be impractical because the administrative costs of providing the compensation could outweigh the compensation itself. Thus, in some embodiments, other methods of compensation are employed that are more practical for rewarding users based on a relatively few number of views. For example, in some embodiments, users whose uploaded content has been viewed may receive an entry into a sweepstakes (e.g., a random drawing). The chance of a user winning a sweepstakes may be proportional to the number of times that the user's content has been viewed. Thus, users whose content has been viewed a large number of times are the most likely users to win a prize of value via the sweepstakes, but users whose content is viewed a small number of times have a chance to win a prize and therefore also have incentive to host their content via a hosting service that employs such a system of compensation.

Applicants have further appreciated that conventional systems reward users who generate the content, but not the viewers of such content. Thus, some embodiments are directed to hosting on a server digital media assets that have been uploaded to the server by users. When a digital media asset is accessed by a viewer, the viewer may be presented with a reward. As used herein, the term reward includes both prizes of value and promotional opportunities. A prize of value includes goods and services of direct value. A promotional opportunity is an opportunity to win a prize of value. Thus, for example, a prize of value may be cash, a gift certificate, a t-shirt, or any other goods or services of value, whereas a promotional opportunity may be, for example, an opportunity to enter a sweepstakes drawing, the winner of which receives a prize of value.

In some embodiments, in addition to rewarding a viewer of a digital media asset, the user who uploaded the digital media asset may be presented with a reward (e.g., a promotional opportunity, a prize of value, or some other reward). This encourages users who generate content to host their content via hosting service that uses such a compensation. It also encourages viewers to view content hosted via the hosting service, which may generate increased traffic that can be monetized (e.g., by displaying advertisements).

As discussed above, in some embodiments, a user is rewarded when content generated by the user is viewed. In some embodiments, techniques are employed to associate the user who posted the content with content so that the user can be identified when the content is viewed. For example, some embodiments are directed to a hosting server that publishes a digital media asset uploaded by a user. An activatable item, such as a selectable icon, image, or text link, may be published with and associated with the digital media asset. When a viewer of the digital media assets activates (e.g., selects) the activatable item, information identifying the user who uploaded the asset may be sent to a target server. The information identifying the user who uploaded the asset may be used to identify the user and when it is determined that the viewer has taken an action in connection with accessing the first digital media asset (e.g., accepting a prize of value associated with the promotional opportunity), the user who uploaded the digital media asset may be provided with a reward (e.g., a prize of value, a different promotional opportunity to which the viewer was directed, or the same promotional opportunity).

In some embodiments, when a viewer activates an activatable item associated with a digital media asset, the viewer may be presented with a reward (e.g., by being directed to a promotional opportunity, such as, for example, an opportunity to enter a sweepstakes) in addition to or instead of providing the user who uploaded the digital media asset with a reward.

As discussed above, embodiments of the present invention relate to rewarding users whose uploaded content has been viewed and/or rewarding the viewers of this content. Computer systems that accomplish this may be implemented in any suitable way, as the invention is not limited in this respect. Examples of some implementations of such computer systems are discussed below. However, the implementations discussed below are merely examples of implementations that may be used in some embodiments and the invention is not limited to these or other particular implementations.

In some embodiments, one or more hosting servers may provide a service that allows users to upload content to be stored on the one or more servers. This may be done in any suitable way, as the invention is not limited in this respect. For example, in some embodiments, the one or more hosting servers may provide an interface (e.g., a world wide web interface) that allows a user to create a user account and upload digital media assets to the hosting server. Such user accounts are not accounts that require administrative privileges to receive, but rather are accounts that any eligible Internet user may create (e.g., by agreeing to the terms of service and/or meeting any eligibility standards, such as minimum age requirements).

In some embodiments, a user account is a type of account for which more than five percent of the members of the Internet community meet the eligibility standards.

Thus, in such embodiments, an account that is used by a web site administrator, developer, or other employee that has a higher level of privileges (e.g., administrative privileges) would not qualify as a user account because such an account is available only to select persons (e.g., employees of the web site's company) and five percent of the members of the Internet community do not meet the eligibility requirements for receiving such an account. In other embodiments, a user account is a type of account for which more than one tenth of one percent of the members of the Internet community meet the eligibility requirements. In other embodiments, a user account is a type of account for which more than one percent of the members of the Internet community meet the eligibility requirements. In other embodiments, a user account is a type of account for which more than ten percent of the members of the Internet community meet the eligibility requirements. In other embodiments, a user account is a type of account for which more than twenty percent of the members of the Internet community meet the eligibility requirements. In other embodiments, a user account is a type of account for which more than fifty percent of the members of the Internet community meet the eligibility requirements.

In some embodiments, a user account is a type of account for which more than two million members of the general public meet the eligibility standards. In other embodiments, a user account is a type of account for which more than one million members of the general public meet the eligibility standards. In other embodiments, a user account is a type of account for which more than 500,000 members of the general public meet the eligibility standards. In other embodiments, a user account is a type of account for which more than 250,000 members of the general public meet the eligibility standards. In other embodiments, a user account is a type of account for which more than 100,000 members of the general public meet the eligibility standards. In other embodiments, a user account is a type of account for which more than 25,000 members of the general public meet the eligibility standards.

In some embodiments, a user account is a type of account which any Internet user may create upon agreeing to specified terms of service. That is, creation of the account is performed automatically and there is no validation that a user creating the account meets eligibility requirements provided in the terms of service other than the user's acceptance of the terms of service.

As used herein, a digital media asset or asset refers to any digital content, including for example, a still image, a video, a slideshow, an animation, an audio clip, a text document, a web page, or any other digital content. Portions of the present application use the phrase “viewing” a digital media asset. It should be appreciated that in embodiments in which the digital media asset is an audio clip or other digital content, the term “viewing” the digital media asset is intended to include listening to an audio clip or listening to the audio portion of some other digital content.

The one or more hosting servers may select digital media assets to be “published” (i.e., made available to viewers for viewing) in any suitable way. In some embodiments, a user may instruct the one or more servers to publish some or all of the digital media assets that he or she has uploaded to enable other viewers to access them. In other embodiments, the one or more hosting servers may publish every digital media asset uploaded by the user.

The one or more hosting servers may publish a digital media asset in any suitable way, as the invention is not limited in this respect. For example, in some embodiments, the one or more hosting servers may publish a digital media asset via e-mail. This may be done in any suitable way. For example, in some embodiments, the user may instruct the hosting server(s) to publish the digital media asset via e-mail, may provide the hosting server(s) with the e-mail address(es) of one or more viewers, and the hosting server(s) may generate one or more e-mails that include the digital media asset and may send the e-mail(s) to the e-mail address(es) provided by the user.

The hosting server may include the digital media asset in the e-mail in any suitable way, as the invention is not limited in this respect. For example, in some embodiments, the hosting server may include the digital media asset as an attachment to the e-mail (e.g., the binary data that forms the digital media asset is sent along with the binary date that forms the e-mail).

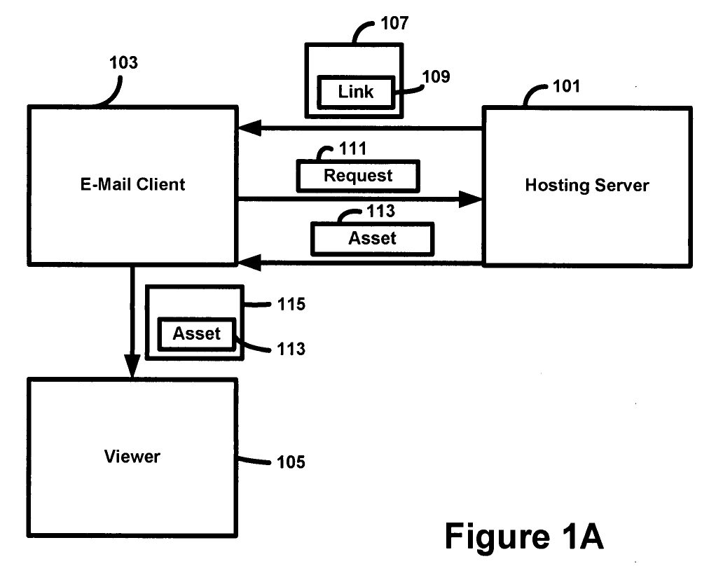

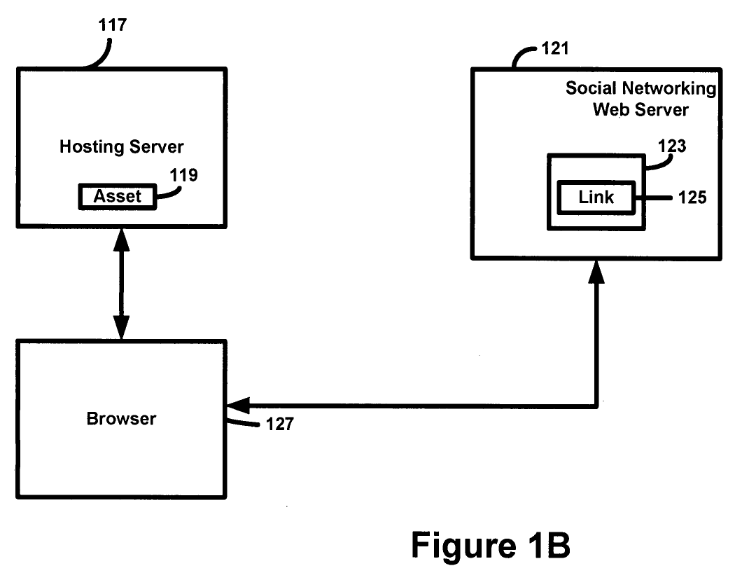

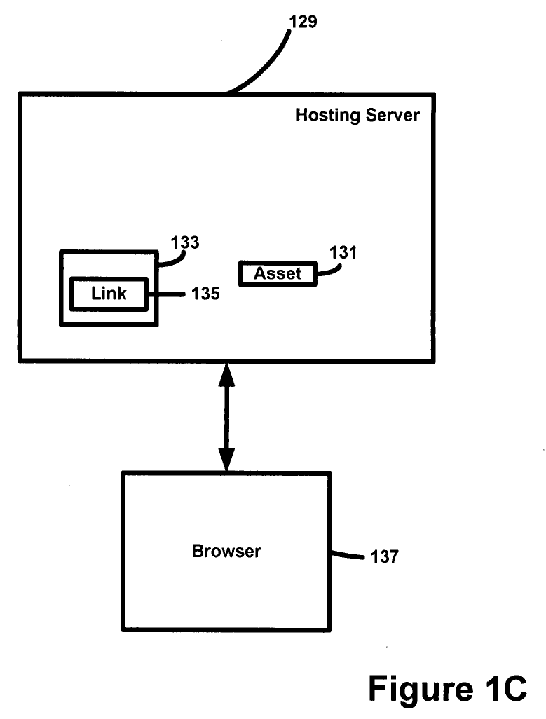

In other embodiments, rather than including the digital media asset as an attachment, the e-mail may include a link (e.g., a world wide web link) to the digital media asset. When an e-mail with such a link is received by the viewer's e-mail client, the e-mail client may use the link to request that the hosting server send the asset. For example, as shown in FIG. 1A, a hosting server 101 may send an e-mail 107 to a viewer's e-mail address. E-mail 107 may include a link 109 to a digital media asset 113 stored on the hosting server 101. The e-mail client 103 of viewer 105 may receive e-mail 107 (e.g., via an e-mail server to which the viewer's e-mail address resolves) and may recognize that the e-mail includes link 109. The e-mail client may use the information in the link to send a request 111 for the digital media asset identified by the link to hosting server 101. In response, hosting server 101 may send digital media asset 113 to e-mail client 103 and e-mail client 103 may display an e-mail 115 to viewer 105 that includes digital media asset 113.

In some embodiments, the hosting server(s) may publish a digital media asset via another server. This may be done in any suitable way, as the invention is not limited in this respect. For example, some web sites, such as social networking web sites (e.g., MySpace.com), allow users to create personal web pages that are hosted by the web sites' servers. Typically, users of these web sites can view other users' pages and can exchange messages with them. Many social networking sites provide the ability to link to content hosted elsewhere (e.g., on another hosting server designed to share content such as photos, videos, or other content). Thus, in some embodiments, a digital media asset stored on a hosting server incorporating aspects of the present invention may be published by including a link to the digital media asset in a web page hosted by some other server (e.g., a server associated with a different web site, such as a social networking site).

For example, as shown in FIG. 1B, digital media asset 119 may be stored on hosting server 117, that may employ any of the embodiments described herein. In addition, social networking web server 121 (i.e., a web server that hosts a social networking web site) may serve a web page 123 that includes a link 125 to digital media asset 119. A viewer may access web page 123 via a world wide web browser 127, which requests the web page from social networking web server 121, recognizes that the web page includes a link 125, and uses the information in link 125 to request digital media asset 119 from hosting server 117. In response to the request, hosting server 117 may send digital media asset 119 to browser 127 and browser 127 may display web page 123, including digital media asset 119 to the viewer.

In some embodiments, hosting server 117 may generate link 125 for use in the web page 123. For example, the user that uploaded digital media asset 119 to hosting server 117 may request that the hosting server generate a link that links to digital media asset 119. Hosting server 117 may generate a link (e.g., in the form of HTML code or in any other form) and provide it to the user (e.g., via the user's browser). The user may place this link (e.g., the HTML code) in a web page that the user has created on another web site. For example, the user may use the link as link 125 in web page 123. Web page 123 may, for example, be the user's web page hosted on a social networking site, a blog, or any other web page that the user selects. The user may wish to display asset 119 hosted on hosting server 117 in his web page 123. Thus, the user may obtain a link to that asset from hosting server 117 and place that link in his web page 123.

In some embodiments, the hosting server(s) may publish a digital media asset directly, and not via another server. For example, as shown in FIG. 1C, hosting server 129 may store a digital media asset 131 and a web page 133 that includes a link 135 to digital media asset 131. A viewer, via a browser 137, may send a request to hosting server 129 for web page 133 and, in response, the hosting server may provide the web page to the browser. The browser may receive the web page, recognize that it includes a link 135 to digital media asset 131 and may use the information in the link to request the digital media asset from hosting server 129. Hosting server 129 may provide the digital media asset to browser 137 and browser 137 may display web page 133 including digital media asset 131 to the user.

FIG. 1B depicts a web page 123 on web server 121 and FIG. 1C depicts a web page 133 on hosting server 129, each of which includes a link to a digital media asset. It should be appreciated that these web pages may be static web pages stored on their respective servers or may be dynamically created web pages that are generated by their respective servers is response to a received request.

FIGS. 1A-1C illustrate examples of ways to publish user-generated content. The embodiments described herein can be used with any of these ways, or any other suitable technique for publishing content, as the invention is not limited in this respect.

As discussed above, in some embodiments, when a viewer accesses a user-generated digital media asset that is published by the hosting server(s) (e.g., in any of the ways discussed above or any other suitable way), the viewer may be provided with a reward. The viewer may be provided with any suitable reward, as the invention is not limited in this respect. In some embodiments, for example, the viewer may be directed to a promotional opportunity (e.g., an opportunity to enter a sweepstakes drawing to win a prize of value). Thus for example, in some embodiments, a viewer may be presented with the opportunity to enter a random drawing to win a prize.

In other embodiments, the reward may be, for example, a prize of value (e.g., cash, a gift certificate, or any other goods or services of value). That is, for example, when a viewer accesses a digital media asset published by the hosting server(s), the viewer may be informed that he or she has been awarded a prize of value that he or she has the opportunity to accept. In other embodiments, a “drawing” of sorts is performed to select a particular viewer of content hosted by the hosting server as a winner. That is, for example, the hosting server may award a prize of value (e.g., a cash prize, gift certificate, or any other prize of value) to the first n viewers (where n may be any suitable number) to view content hosted on the hosting server during a particular time range. No particular viewer is guaranteed to win a prize, because a viewer cannot guarantee that he or she will be among the first n viewers. Thus, when a viewer views content hosted on the hosting server, the hosting server may determine whether the viewer is among the first n viewers, and if so, present the viewer with the opportunity to accept a prize of value.

A viewer may be presented with a reward in any suitable way, as the invention is not limited in this respect. For example, in some embodiments, the hosting server may publish an activatable item with the digital media asset. When the viewer activates the activatable item, he or she may be directed to the reward.

The hosting server(s) may publish the activatable item in any suitable way, as the invention is not limited in this respect. For example, in some embodiments, when the digital media asset is published in an e-mail, the activatable item may also be published in the e-mail or as an attachment thereto. For example, in FIG. 1A, asset 113 may be published with an activatable item by including the activatable item in e-mail 107 (e.g., as an attachment or otherwise) and/or by including a link to the activatable item with link 109.

In some embodiments, when the digital media asset is published via a web page 123 on another sever, as discussed above in connection with FIG. 1B, the activatable item may be published by, for example, including the activatable item and/or a link to the activatable item in the web page 123. Similarly, in embodiments in which the digital media asset is published via a web page 133 hosted by the hosting server, as discussed above in connection with FIG. 1C, the web page 133 may include the activatable item and/or a link to the activatable item.

Any suitable activatable item may be used, as the invention is not limited in this respect. In some embodiments, the activatable item may be a selectable image that is published with (e.g., on or near) the digital media asset, although any type of activatable items can be employed. When the activatable item is activated (e.g., selected), the viewer may be directed to a target server that presents the viewer with a reward, such as, for example, a promotional opportunity or a prize of value.

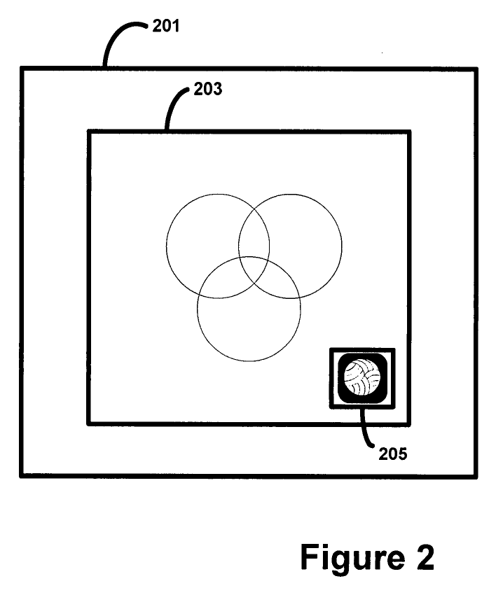

For example, as shown in FIG. 2, a web page 201 includes a digital media asset 203 hosted on and published by one or more hosting servers and a selectable image 205 also hosted on and published by the hosting server(s) that is overlaid on digital media asset 203. When a viewer selects selectable image 205 (e.g., by clicking on it with a mouse or in any other suitable way), the viewer's browser may be directed to a target server that presents the viewer with the promotional opportunity. This may be done in any suitable way, as the invention is not limited in this respect. For example, in embodiments in which digital media asset 203 and selectable image 205 are delivered and accessed via the world wide web, the selectable image may be made selectable using standard HTML techniques (e.g., using the HTML <a> tags) and may re-direct the viewer's web browser to a target server (which as discussed above may be the same server as the hosting server that hosts the digital media asset or a different server) that hosts a web page that presents the viewer with the promotional opportunity.

In the example of FIG. 2 selectable image 205 is overlaid on digital media asset 203. However, the invention is not limited in this respect, as an activatable item may be associated with a digital media asset in any suitable way. For example, the activatable item may be associated with the digital media asset by being placed next to or near the digital media asset on web page 201. Indeed, the activatable item may be associated with the digital media asset by being placed in any location on web page 201 such that it is visually and/or logically associated with the asset.

In some embodiments, the activatable item may be a hypertext link (e.g., an HTML link) that when activated (i.e., selected) directs the viewer to a reward. This may be done in any suitable way. For example, the hypertext link may direct the viewer to target server (which as discussed above may be the same server as the hosting server that hosts the digital media asset or a different server) that hosts a web page that presents the viewer with the reward.

In some embodiments, the activatable item may be the digital media asset itself. For example, the digital media asset may be made to be selectable in any suitable way and, when selected, may direct the viewer to a reward.

In some embodiments, the digital media asset may be a computer program or a portion of a computer program, such as a Flash™ animation or movie, a Java™ program, or a Java™ applet, or other program that displays digital content. The activatable item may be a portion of such a program, such as an image or icon displayed by the program, or some other portion of the program. In some embodiments, when the viewer activates the activatable item, the computer program may direct the viewer (e.g., via the viewer's browser) to a target server that presents the viewer with a web page that presents the user with a reward. In other embodiments, when the viewer activates the activatable item, the computer program may directly present the viewer with the reward. For example, in embodiments where the computer program is Flash™ program, when the viewer activates the activatable item, the Flash™ player may display a promotional opportunity or opportunity to accept a prize of value.

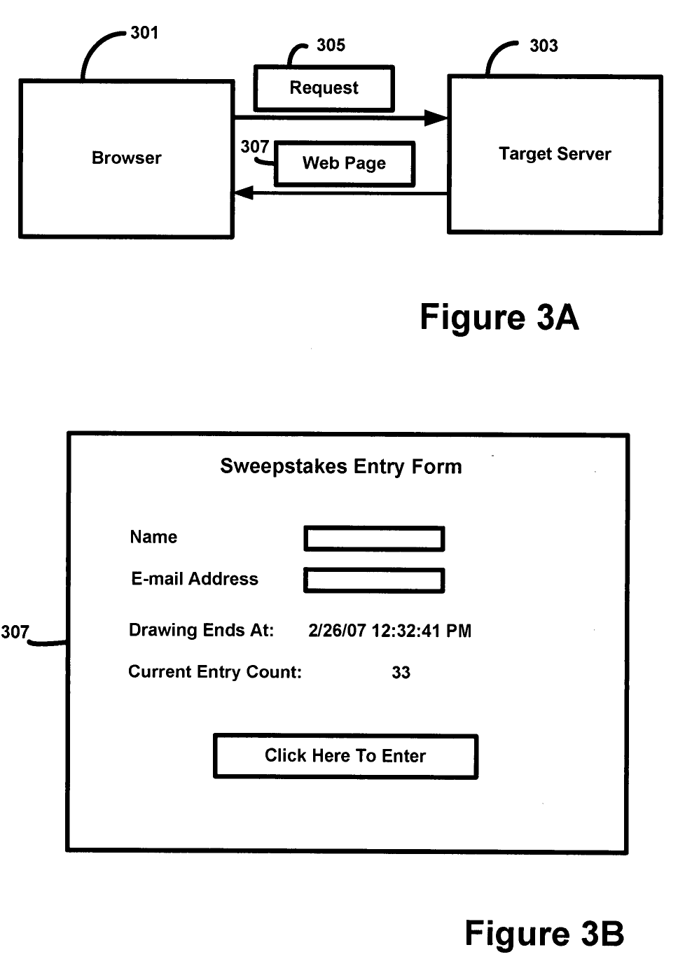

When the viewer activates the activatable item, the viewer may be directed to the reward in any suitable way, as the invention is not limited in this respect. As discussed above, in some embodiments, the viewer may be directed to a web page on a target server that presents the viewer with a reward. For example, as shown in FIG. 3A, the viewer selecting an activatable item may cause the viewer's browser 301 to send a request 305 to a target server 303 for a web page 307. In response to the request 305, target server 303 may provide web page 307 to browser 301. Web page 307 may include any suitable information to present the viewer with the reward, as the invention is not limited in this respect. For example, as shown in FIG. 3B, in some embodiments in which the reward is a promotional opportunity, such as a sweepstakes, web page 307 may include a form that permits the viewer to enter a sweepstakes. In FIG. 3B, web page 307 includes entry fields for the viewer to enter his or her name and e-mail address, and includes information specifying when the sweepstakes drawing ends and the current number of entries in the sweepstakes. It should be appreciated that the information included in web page 307 in FIG. 3B is by way of example, as embodiments of the invention wherein the promotional opportunity is entry into a sweepstakes are not limited to including any particular information in such a web page. For example, the viewer can be identified in ways other than a name and e-mail address and any information provided to the viewer regarding the sweepstakes is optional.

As discussed above, in some embodiments in which the activatable item is displayed by a computer program, such as, for example, a Flash™ animation, the computer program may display the reward to the viewer. Thus, for example, in embodiments in which the computer program is Flash™ program and the reward is a promotional opportunity, the flash player may display a form such as the form shown in web page 307 in FIG. 3B, or any other promotional opportunity.

The examples above describe some embodiments in which the digital media asset is accessed via the world wide web using a world wide web browser and in which a viewer is directed to and presented with a reward via the world wide web. However, it should be appreciated that the invention is not limited in this respect, as the digital media asset need not be accessed or viewed via the world wide web and may be accessed or viewed in any suitable way. Further, the viewer may need not be directed to the reward or presented with the reward via the world wide web, as this may be done in any suitable way and the invention is not limited in this respect.

In some embodiments, in addition to, or as an alternative to rewarding a viewer for viewing a digital media asset, when a viewer views a digital media asset published by the hosting server that was uploaded to the hosting server by a user, the user may be rewarded. This may be done in any suitable way, as the invention is not limited in this respect

In some embodiments, the user who uploaded a digital media asset may be provided with a reward (e.g., a prize of value or a promotional opportunity) when a viewer accesses the digital media asset and/or takes any suitable action resulting from accessing the digital media asset. For example, in some embodiments in which the digital media asset is published with an activatable item, the action taken by the viewer may be activating the activatable item. Thus, when the viewer of a digital media asset activates the activatable item (which may occur automatically from accessing the asset or may require an affirmative action by the viewer), the user who uploaded the digital media asset to the hosting server(s) may receive a reward (e.g., a promotional opportunity or a prize of value).

In other embodiments, the action taken by the viewer may be accepting a promotional opportunity provided to the viewer as a result of accessing the content. Thus, for example, when a viewer of a digital media asset views the digital media asset and, as a result, is directed to a reward (e.g., an opportunity to enter a sweepstakes to win a prize of value or to directly receive a prize of value), when the viewer accepts the opportunity (e.g., enters the sweepstakes or accepts the directly awarded prize of value), the user who uploaded the digital asset may be provided with a reward.

In other embodiments, the action taken by the viewer may be accepting or claiming a prize associated with the promotional opportunity. For example, in some embodiments in which the viewer receives a promotional opportunity and the promotional opportunity received by the viewer is an entry into a sweepstakes, if the viewer accepts the promotional opportunity (i.e., enters the sweepstakes) and wins the sweepstakes, then when the viewer accepts or claims his or her prize for winning the sweepstakes, the user who uploaded the digital asset may be provided with a reward.

The actions by the viewer resulting from the viewer accessing the content described above are provided merely as examples of actions that a viewer may take, and the invention is not limited to these examples.

In embodiments wherein the user who uploaded a digital media asset is rewarded when the asset is accessed (or in response to an action taken resulting from such an access), the user may be rewarded with any reward, as the invention is not limited in this respect. In some embodiments, the reward may be a promotional opportunity, such as, for example, an entry into a sweepstakes drawing. In embodiments in which the viewer of a digital media asset uploaded by the user receives an entry into a sweepstakes, the user who uploaded the asset may be entered into the same sweepstakes. However, the invention is not limited in this respect as the user and the viewer need not be entered into the same sweepstakes and may be entered into different sweepstakes.

In some embodiments, the reward received by the user may be a prize of value, such as a cash prize, a gift certificate, merchandise, services, or any other suitable prize of value, either instead of or in addition to entry into a sweepstakes.

In embodiments in which a user who uploaded a digital media asset is rewarded when the digital media asset is accessed, techniques may be employed to associate the user's identity with the content to facilitate identifying the user to be rewarded. This may be done in any suitable way, as the invention is not limited in this respect. In some embodiments in which a digital media asset is published with an associated activatable item, a viewer of the digital media asset activating the activatable item may cause information identifying the user who uploaded the asset to be transmitted to a target server that manages the process of rewarding the user who uploaded the digital media asset. This may be done in any suitable way, as the invention is not limited in this respect.

For example, in some embodiments, activating the activatable item may cause the viewer's browser to access a target server using a Uniform Resource Locator (URL) that includes, as an attribute, information identifying the user who uploaded the asset. For example, as shown in Table 1, a URL may identify the target server (i.e., sharethat.com), a web page (prizepage.html), and an attribute/value pair (i.e., id=12345) that may include any identifier of a use who uploaded the asset. Thus, a viewer activating the activatable item may cause the viewer's browser to request the web page prizepage.html from the target server and to send the attribute/value pair to the target server. The value in the attribute value pair may be used to identify the user in any suitable way. For example, a user may have an account with the hosting server and the attribute/value pair may identify the account, although other techniques are possible/.

TABLE 1
http://www.sharethat.com/prizepage.html?id=12345

The activatable item, when activated, may cause this identifying information to be sent in any suitable way, as the invention is not limited in this respect. For example, in some embodiments in which the activatable item is a selectable image or hypertext link, when the activatable item is published, it may be published to link to a URL that includes an attribute/value pair identifying the user who uploaded the asset. Thus, for example, in some embodiments in which the hosting server(s) publish(es) the digital media asset and associated activatable item in an e-mail, the hosting server(s) may identify the user that uploaded the digital media asset, and publish the activatable item to link to a URL that includes and attribute/value pair with information identifying the user. Thus, when a viewer selects the activatable item, the viewer's browser will access the URL, causing the information identifying the user to be transmitted to the target server.

As discussed above, in some embodiments in which the hosting server(s) publish(es) the digital media asset and associated activatable item via another server (e.g., as discussed above in connection with FIG. 1B), the hosting server(s) may generate a link to be placed in a web page hosted by the other server. The link may include the activatable item and/or a link to the activatable item, and may cause the activatable item, when selected, to link to a URL that includes the attribute/value pair that identifies the user who uploaded the digital media asset.

In some embodiments, instead of or in addition to using an attribute/value pair in a URL to identify a user who uploaded a digital media asset, a web beacon or web bug may be used. This may be done in any suitable way, as the invention is not limited in this respect. A web beacon or web bug is any digital data embedded in a web page that is not intended to be viewed or recognized by a viewer of the web page. For example, a web beacon or web bug may be small transparent image that is placed within a web page or e-mail and that can be used to track when the page or e-mail has been viewed. That is, a web page or e-mail that includes a link to a digital media asset may also be associated with (e.g., include a URL that links to) the web beacon or web bug. This URL may include as an attribute information identifying the user who uploaded the digital media asset to the hosting server(s). Thus, when a browser accesses the web page, the browser will request the web beacon from the server identified by the URL and will transmit the attribute/value pair that identifies the user. In such embodiments, the user who uploaded a digital media asset may be determined when a viewer views the digital media asset, without requiring that the digital media asset be published with an activatable item and without requiring that a viewer activate the activatable item.

In other embodiments, a cookie may be used to transmit information identifying the user who uploaded a digital media asset, in addition to or instead of using a link or a web beacon or web bug. This may be done in any suitable way, as the invention is not limited in this respect. A cookie is a small piece of data that a web browser stores on a client computer (e.g., the computer on which it executes) at the request of a web server. The web browser may send back data within the cookie to the web browser that requested its creation each time the user visits an authorized web page with that specific web server's domain. Thus, when a viewer views a web page that includes a digital media asset, the server that hosts the web page may request the viewer's web browser to store a cookie that includes information identifying the user who uploaded the digital media asset. When the viewer subsequently accesses another web page in the web server's domain (e.g., to receive a reward), the web server may retrieve the information in the cookie and identify the user that uploaded the digital media asset.

In some embodiments, when the digital media asset is part of or is displayed by a computer program (e.g., a Flash™ program), the program may have information identifying the user. Thus, for example, when a viewer selects an activatable item displayed by the program, the program may transmit the information identifying the user who uploaded the asset to the target server.

The examples above are some examples of way to identifier a user who uploaded a viewed digital media asset. The invention is not limited to these particular ways, as any suitable technique of identifying the user may be used, and the invention is not limited in this respect.

The information identifying the user who uploaded the digital media asset may be any suitable information, as the invention is not limited in this respect. For example, the information may be information that directly identifies the user to the hosting server (e.g., a user name, user identification number, or an account identifier) or may be information that indirectly identifies the user.

For example, the hosting server(s) may have a data set that maps any type of identifying information to corresponding users. In some embodiments, the hosting server(s) may store information that tracks the digital media assets uploaded by a particular user. This may be done in any suitable way, as the invention is not limited in this respect. For example, the hosting server(s) may assign each digital media asset an identifier and may associate the identifiers for each digital media asset with an identifier for the user in any suitable way (e.g., in a database or other data set). Thus, the information identifying the user may be, for example, the identifier for the digital media asset that the user has viewed. This information may be used to determine the user who uploaded the digital media asset by accessing the information that associates the digital media asset identifier with the identifier for the user.

In some embodiments, the hosting server(s), in addition to or instead of creating and storing an identifier for each digital media asset uploaded by a user, may store information identifying each published instance of digital media asset. This may be done in any suitable way, as the invention is not limited in this respect. For example, each time that a digital media asset is published (e.g., in an e-mail or via a web page hosted on another server), the hosting server(s) may create an identifier for that publication of the digital media asset. Thus, if the digital media asset is published three times (e.g., in two e-mails and in one web page hosted on another server), then the hosting server(s) may create three identifiers, each identifying one publication of the digital media asset. These identifiers may be associated with the user who uploaded the asset and/or the digital media asset itself in any suitable way (e.g., in a database). Thus, the information identifying the user may be an identifier that identifies the publication of the digital media asset. This information may be used to determine the user who uploaded the digital media asset by accessing the information that associates the publication identifier with the digital media asset identifier and/or information identifying the user who uploaded the digital media asset.

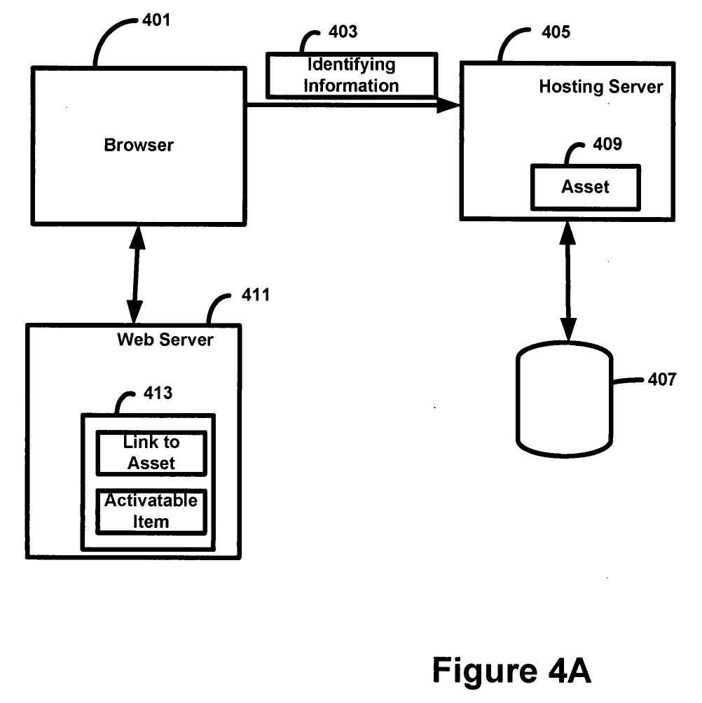

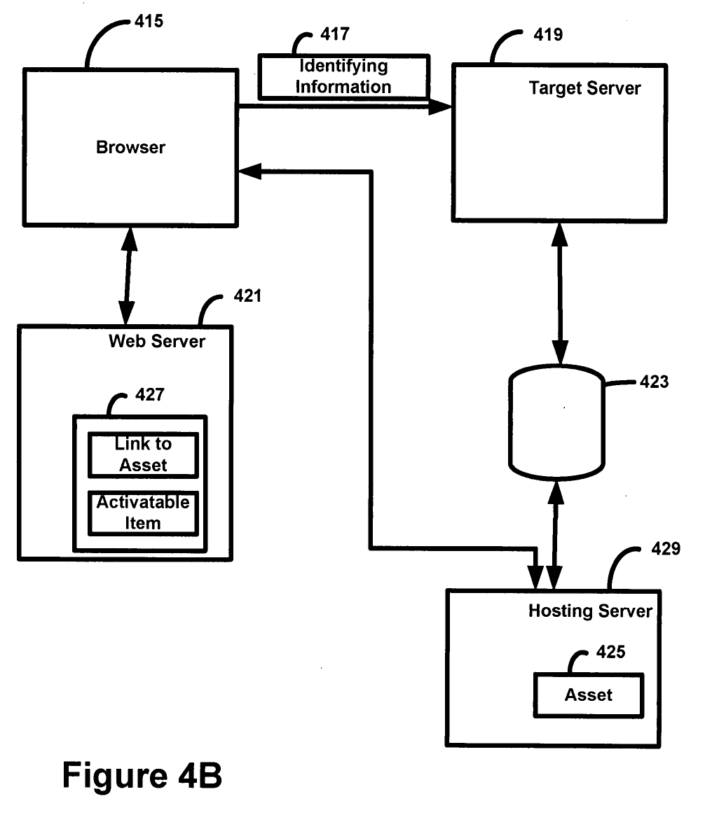

As discussed above, in some embodiments, the information identifying the user may be transmitted to a target server. Any suitable target server may be used, as the invention is not limited in this respect. For example, in some embodiments, the target server may be the server that hosts the digital media asset. That is, as shown in FIG. 4A, browser 401 may access a web page 413 hosted on a web server 411. The web server 411 may include a link to asset 409 stored on hosting/target server 405 and may include an activatable item. As discussed above in connection with FIG. 1B, the browser may request asset 409 from hosting/target server 405 and may receive the asset from the hosting server. The browser may then display web page 413 including asset 409 to a viewer. The viewer's activating the activatable item on web page 413 may cause browser 401 to transmit identifying information 403 (e.g., in the form of a URL, web beacon, cookie, or another form) to hosting/target server 405. Hosting/target server 405 may use information stored in information store 407 to use identifying information 403 to reward the user identified by the identifying information with a prize of value in any of the ways discussed above.

In some embodiments, the target server may be a different server from the hosting server that hosts the digital media asset. For example, as shown in FIG. 4B, browser 415 may access a web page 427 hosted on a web server 421. Web server 421 may include a link to asset 425 stored on hosting server 429 and may include an activatable item. As discussed above in connection with FIG. 1B, the browser may request asset 425 from hosting server 429 and may receive the asset from the hosting server. The browser may then display web page 427 including asset 425 to a viewer. The viewer's activating the activatable item on web page 427 may cause browser 415 to transmit identifying information 417 (e.g., in the form of a URL, web beacon, cookie, or another form) to target server 419. In some embodiments, target server 419 may access information stored in information store 423 to use identifying information 417 to reward the user identified by the identifying information.

In some embodiments in which a digital media asset is published via the hosting server that hosts the digital media asset (e.g., as discussed above in connection with FIG. 1C), when a digital media asset is accessed by a viewer and/or the viewer takes an action resulting from accessing, the hosting server may determine the user who uploaded the digital media asset in any suitable way, as the invention is not limited in this respect.

In some embodiments in which the user is rewarded as a result of a viewer accessing a digital media asset uploaded by the user (without the user taking any additional action), when the viewer accesses the digital media asset from the hosting server, the hosting server may determine the user who uploaded the asset by accessing information that associates the asset with the user, as discussed above. In some embodiments in which the digital media asset is published with an associated activatable item and the user who uploaded the digital media asset receives a prize of value as a result of the viewer accessing the digital media asset and activating the activatable item, the viewer's activating the activatable item may cause information identifying the user to be transmitted to the hosting server and the hosting server may use this information to provide the user with a prize of value in any of the ways discussed above.

In some embodiments, a user is not provided with a prize of value each time his or her asset is accessed by a viewer (or each time the viewer takes an action resulting from accessing the asset). This may be implemented in any of numerous ways. For example, in one embodiments, the user may be provided with a prize (e.g., an entry into a sweepstakes) for every n times (where n may be any suitable number) his or her asset is accessed by a viewer (or a viewer takes an action resulting from accessing the asset).

Alternatively, a user may be provided with a prize of value for each occurrence, but only after the asset has been accessed m times (or after m viewers have taken an action resulting from viewing the asset), where m may be any suitable number. Thus, for example, if m is five, then after a user's asset has been viewed five times, the user may receive an entry into a sweepstakes or some other prize of value for every subsequent occasion on which his or her asset is viewed. Alternatively, in some embodiments, a user may be provided with an entry into the sweepstakes for every n views or every n actions taken resulting from the asset being viewed or accessed after the assets has been accessed m times or after m actions have been taken.

As discussed above, m and n may be any suitable number and need not be the same number (although they may). For example, m and/or n may be relatively small, preferably less than twenty thousand, more preferably less than 10,000, more preferably less than 5,000, more preferably less than 500, more preferably less than 200, more preferably less than 100, more preferably less than 50, and more preferably less than 10.

As discussed above, in some embodiments, a user that has uploaded content and/or a viewer of uploaded content may receive as a reward an entry into a sweepstakes. The sweepstakes may be conducted in any suitable way, as the invention is not limited in this respect.

For example, in some embodiments, sweepstakes may be conducted at a regular interval (e.g., one drawing per hour) or some other interval (e.g., a non-regular interval). When a viewer or user is offered entry into a sweepstakes and enters the sweepstakes or is entered automatically, the viewer or user may be placed into the next drawing or any other suitable drawing.

A viewer or user may be placed into a drawing in any suitable way. For example, the hosting server and/or target server may store information identifying each drawing and may store a list of viewers and/or users that are entered into that drawing. Thus, a viewer or user may be entered into a drawing by being added to the list of viewers or users in the drawing. In some embodiments, when a viewer or user is entered into a drawing, information may be stored identifying the digital media asset which the viewer viewed to obtain entry into the sweepstakes and/or information identifying the user who uploaded that digital media asset, although the invention is not limited in this respect. Similarly, in some embodiments, when a user is entered into a drawing, information may be stored identifying the digital media asset that was accessed to provide the user with the entry into the sweepstakes, although the invention is not limited in this respect.

The drawing may occur in any suitable way, as the invention is not limited in this respect. For example, in some embodiments, when the scheduled time for a drawing to occur arrives, one viewer or user from the list of viewers and/or users in the drawing may be selected at random.

The winner of sweepstakes may be notified in any suitable way, as the invention is not limited in this respect. For example, in some embodiments, when a viewer of an asset enters a sweepstakes the viewer may provide his or her e-mail address. If the viewer wins the sweepstakes, the viewer may be notified via an e-mail that includes the prize or instructions for claiming the prize.

In some embodiments, when a user who uploaded an asset is entered into a sweepstakes and wins, a notification that user has won may be sent to the user via his account or via an e-mail sent to the e-mail address that the user provided upon creating the account.

The sweepstakes may be conducted by any suitable server, as the invention is not limited in this respect. For example, in some embodiments, the sweepstakes may be conducted by the hosting server. In other embodiments in which the hosting server and the target server are different servers, the sweepstakes may be conducted by the target server.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one computer-readable medium (e.g., a computer memory, a floppy disk, a compact disk, a tape, etc.) encoded with a computer program (i.e., a plurality of instructions), which, when executed on a processor, performs the above-discussed functions of the embodiments of the present invention. The computer-readable medium can be transportable such that the program stored thereon can be loaded onto any computer environment resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

It should be appreciated that in accordance with several embodiments of the present invention wherein processes are implemented in a computer readable medium, the computer implemented processes may, during the course of their execution, receive input manually (e.g., from a user).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of hosting a first digital media asset stored on at least one server that provides a publicly accessible interface that permits digital media assets to be provided to the at least one server, the first digital media asset being provided to the at least one server by a user via the publicly accessible interface, the method comprising acts of:
determining that a viewer has accessed the first digital media asset; and
in response to determining that the viewer has taken an action resulting from accessing the first digital media asset, providing the user with a promotional opportunity.

2. The method of claim 1, wherein the action comprises accessing the first digital media asset.

3. The method of claim 1, wherein the promotional opportunity is a first promotional opportunity and wherein the method further comprises an act of:
in response to determining that the viewer has accessed the first digital media asset, directing the viewer to a second promotional opportunity.

4. The method of claim 3, wherein the first promotional opportunity and the second promotional opportunity are a same promotional opportunity.

5. The method of claim 3, wherein the second promotional opportunity is an opportunity to enter a sweepstakes, and wherein the action comprises claiming a prize offered as a result of the viewer winning the sweepstakes.

6. The method of claim 3, wherein the second promotional opportunity is an opportunity to enter a sweepstakes, and wherein the action comprises winning the sweepstakes.

7. The method of claim 3, wherein the second promotional opportunity is an opportunity to enter a sweepstakes, and wherein the action comprises entering the sweepstakes.

8. At least one computer readable medium encoded with instructions that, when executed, perform a method of hosting a first digital media asset stored on at least one server that provides a publicly accessible interface that permits digital media assets to be provided to the at least one server, the first digital media asset being provided to the at least one server by a user via the publicly accessible interface, the method comprising acts of:
determining that a viewer has accessed the first digital media asset; and
in response to determining that the viewer has taken an action resulting from accessing the first digital media asset, providing the user with a promotional opportunity.

9. The at least one computer readable medium of claim 8, wherein the action comprises accessing the first digital media asset.

10. The at least one computer readable medium of claim 8, wherein the promotional opportunity is a first promotional opportunity and wherein the method further comprises an act of:
in response to determining that the viewer has accessed the first digital media asset, directing the viewer to a second promotional opportunity.

11. The at least one computer readable medium of claim 10, wherein the first promotional opportunity and the second promotional opportunity are a same promotional opportunity.

12. The at least one computer readable medium of claim 10, wherein the second promotional opportunity is an opportunity to enter a sweepstakes, and wherein the action comprises claiming a prize offered as a result of the viewer winning the sweepstakes.

13. The at least one computer readable medium of claim 10, wherein the second promotional opportunity is an opportunity to enter a sweepstakes, and wherein the action comprises winning the sweepstakes.

14. The at least one computer readable medium of claim 10, wherein the second promotional opportunity is an opportunity to enter a sweepstakes, and wherein the action comprises entering the sweepstakes.

15. At least one server that hosts a first digital media asset comprising:
a publicly accessible interface that permits digital media assets to be provided to the at least one server, the first digital media asset being provided to the at least one server by a user via the publicly accessible interface; and
at least one controller that:
determines that a viewer has accessed the first digital media asset; and
in response to determining that the viewer has taken an action resulting from accessing the first digital media asset, provides the user with a promotional opportunity.

16. The at least one server of claim 15, wherein the action comprises accessing the first digital media asset.

17. The at least one server of claim 15, wherein the promotional opportunity is a first promotional opportunity and wherein the at least one controller:
in response to determining that the viewer has accessed the first digital media asset, directs the viewer to a second promotional opportunity.

18. The at least one server of claim 17, wherein the second promotional opportunity is an opportunity to enter a sweepstakes, and wherein the action comprises claiming a prize offered as a result of the viewer winning the sweepstakes.

19. The at least one server of claim 17, wherein the second promotional opportunity is an opportunity to enter a sweepstakes, and wherein the action comprises winning the sweepstakes.

20. The at least one server of claim 17, wherein the second promotional opportunity is an opportunity to enter a sweepstakes, and wherein the action comprises entering the sweepstakes.
